(19) United States
(12) Patent Application Publication
(10) Pub. No.: US 2018/0214791 A1
(43) Pub. Date: Aug. 2, 2018

(54) VALVE FOR CARRYING OUT A MASS TRANSFER PROCESS

(71) Applicant: BASF SE, Ludwigshafen (DE)

(72) Inventors: Reiner GIESE, Dannenfels (DE); Stefan HAEDICKE, Bobenheim-Roxheim (DE); Egon SCHMIDT, Homburg (DE); Juergen PASCHOLD, Hochspeyer (DE); Torsten ANDRES, Lorsch (DE); Alexey SHILKIN, Ludwigshafen (DE)

(73) Assignee: BASF SE, Ludwigshafen (DE)

(21) Appl. No.: 15/506,036

(22) PCT Filed: Aug. 24, 2015
(86) PCT No.: PCT/EP2015/069339

§ 371 Date: Feb. 23, 2017

(30) Foreign Application Priority Data
Aug. 25, 2014 (EP) 14182081.1

(51) Int. Cl. B01D 3/16; B01D 3/20; B01D 3/30; B01D 5/00

(52) U.S. Cl. CPC B01D 3/163; B01D 5/0012; B01D 3/30; B01D 3/20

(57) ABSTRACT

A valve accommodated in a separation tray including upper (3) and lower (5) trays, a lock (1) formed between the upper (3) and lower (5) trays. The valve (13) includes a closing element (11) configured such that an orifice (9) in the lower tray (5) is closed by the closing element (11) in a first valve position so that liquid flows from the upper tray (3) into the lock (1), and, in a second valve position, the orifice (9) and an orifice (7) in the upper tray (3) are opened so that gas flows through the lock (1) and liquid on the upper tray (3). The closing element (11) is in the form of a hood including a jacket (23) having orifices (21) positioned in such a way that, in the second valve position, gas flows through the orifices (21) into the liquid on the upper tray (3).

The invention relates to a valve for carrying out a mass transfer process, said valve being accommodated in a separation tray comprising an upper and a lower tray, a lock being formed between the upper tray and the lower tray, the valve comprising a closing element which is configured such that an orifice in the lower tray of the lock can be closed by means of the closing element in a first valve position, so that liquid can flow from the upper tray into the lock, and, in a second valve position, the orifice in the lower tray is opened and an orifice in the upper tray is opened, so that gas can flow through the lock and through liquid on the upper tray.

A valve for carrying out a mass transfer process, said valve being accommodated in a separation tray comprising an upper and a lower tray, a lock being formed between the upper tray and the lower tray, the valve being designed such that, in one valve position, gas can flow through the separation tray and is conducted through a liquid standing on the upper tray, and, when the gas supply is interrupted, the valve, in a second valve position, ensures that the liquid can flow from the upper tray into the lock, is known, for example, from EP 2 033 698 A1, EP 2 027 901 A1 or RU 2 237 508 C1. The valves disclosed in these documents comprise in each case a closing element which comprises two valve plates which are connected to one another by means of a spacer web. In a first position of the closing element, an outflow orifice from the valve, through which liquid can flow out from the lower tray onto the separation tray lying beneath, is closed by the lower valve plate. At the same time, the second valve plate is in a position which enables the liquid to flow from the upper tray into the lock. In a second valve position, the closing element is raised, so that gas can flow through the lower orifice in the valve first into the lock and can then flow around the lower valve plate through orifices in the valve housing through the lock in the direction of the upper tray, the gas on the upper tray being conducted through the liquid standing on the tray.

The disadvantage of the methods known from the prior art is that the valves may become blocked, so that the liquid does not flow out of the lock when the gas supply is renewed or too high a gas pressure is necessary in order to open the valve. This may lead to a deterioration in the separating performance. A further disadvantage is that, in the valves known from the prior art, a large orifice cross section is required in the lower tray, so that, at the start of the supply of gas, liquid can flow out of the lock and gas can flow in countercurrent through the orifices. In this case, the gas should not exceed a critical gas velocity at which countercurrent is no longer possible. As soon as the critical gas velocity is exceeded, the liquid can no longer flow out of the lock. Moreover, when the lock is filled with liquid, the gas pulls part of the liquid back onto the upper tray, thus leading to an undesirable remixing of the liquid and therefore to a deterioration in the separating performance of the tray.

The object of the present invention is, therefore, to provide a valve for carrying out a mass transfer process, by means of which, in a first valve position, an orifice in the lower tray of the lock can be closed and, in a second valve position, the orifice in the lower tray is opened and an orifice in the upper tray closing off the lock is opened, said valve functioning in a failsafe manner, so that the valve cannot tilt out of place and consequently cannot become blocked, and in which, when the gas supply is renewed, the liquid can flow out of the lock and the gas flow and liquid flow do not obstruct one another.

This object is achieved by means of a valve for carrying out a mass transfer process, said valve being accommodated in a separation tray comprising an upper and a lower tray, a lock being formed between the upper tray and the lower tray, the valve comprising a closing element which is configured such that an orifice in the lower tray of the lock can be closed by means of the closing element in a first valve position, so that liquid can flow from the upper tray into the lock, and, in a second valve position, the orifice in the lower tray is opened and an orifice in the upper tray is opened, so that gas can flow through the lock and through liquid on the upper tray, the closing element being designed in the form of a hood which comprises a jacket having orifices which are positioned in such a way that, in the second valve position, gas can flow through the orifices into the liquid on the upper tray, and, furthermore, a chimney being comprised, the closing element designed as a hood and the chimney being configured such that the cross section of the chimney is smaller than the cross section of the closing element designed as a hood, and the chimney being connected to the lower tray of the lock and projecting into the lock, or the chimney being connected to the closing element designed as a hood.

By the closing element being configured in the form of a hood, the situation is avoided where the closing element may become tilted in the valve. Moreover, the chimney ensures that, when the gas supply is renewed, as a result of which the closing element is moved into the second valve position, the gas can flow through the lock and at the same time the liquid flows out of the lock. In this case, the gas flows through the chimney and the liquid flowing out of the lock flows through the orifice in the lower tray outside the chimney. As a result of the different ducts through which liquid and gas flow, the individual flows do not obstruct one another. As a result, when the valve is opened, the closing element designed as a hood can be moved into the second position by the gas flow, without the movement of the closing element being able to be influenced adversely by a disturbance of the gas flow caused by the liquid flowing out of the lock. Furthermore, the situation is also thereby avoided where, particularly in the event of a strong gas flow, the liquid is prevented from flowing out of the lock.

If the chimney is connected to the closing element designed as a hood, in a first embodiment the chimney is mounted on the head of the hood, so that a free cross section is formed between the chimney and the jacket of the hood. In a second embodiment, the chimney adjoins the jacket of the hood. The chimney has in this case a smaller cross section than the jacket of the hood. When the closing element is moved out of the first valve position into the second, gas can then flow upward through the chimney and liquid can flow out of the lock downward through the cross section not filled by the chimney.

In order to avoid the situation where the hood is raised too far by the gas flow and remains in the second valve position, in one embodiment of the invention a hood is formed on the upper tray of the lock, against which hood the closing element designed as a hood abuts in the second valve position. So that the gas flow is not obstructed when the closing element designed as a hood abuts against the hood on the upper tray in the second valve position, orifices are preferably formed in the hood on the upper tray and match with the orifices in the jacket of the closing element designed as a hood. Thus, when the closing element designed as a hood is in the second valve position, the gas can flow through the orifices in the closing element designed as a hood and those in the hood on the upper tray into the liquid on the upper tray.

In an alternative embodiment, the chimney has formed on it a stop, against which the closing element designed as a hood abuts with a stop on the jacket, when the chimney is connected to the lower tray. The movement of the closing element designed as a hood is also limited by the stop on the chimney. For this purpose, the closing element designed as a hood abuts with a stop formed on the hood against the stop on the chimney. The movement into the first valve position when the chimney is connected to the lower tray is limited in that, in the first valve position, the closing element designed as a hood lies on the chimney.

The stop on the chimney may be designed, for example, in the form of a bead or of a ring-shaped widening at the upper end of the chimney. Alternatively, it is also possible to design the stop on the chimney as a rib, as part of a rib or else as a pin. The stop on the closing element designed as a hood is, for example, a peripheral rib at the lower end of the jacket. Alternatively, it is also possible to use as a stop a bead or rib directed into the interior of the closing element designed as a hood. In a further alternative embodiment, the stop comprises at least one pin on the jacket of the closing element designed as a hood. This is possible, for example, when the stop on the chimney is designed as a peripheral bead, ring-shaped widening or rib. This ensures that the closing element designed as a hood abuts with the stop designed as pins against the stop on the chimney even when the closing element designed as a hood rotates during its movement.

In order to conduct the gas flow into the interior of the chimney during the mass transfer process, in one embodiment of the invention the lower end of the chimney has a diametral widening. The diametral widening at the lower end enlarges the gas inlet orifice, so that the gas flowing upward is introduced into the chimney. This has at the same time the advantage that less gas flows through the cross section which is located outside the chimney and through which the liquid flows out of the lock. This has the further advantage that the outflow of the liquid is also not obstructed by the gas flowing around the chimney through the cross section outside the chimney. At the same time, the liquid, when it flows out of the lock, is also deflected, as a result of which the gas flow which is directed in the opposite direction to the liquid and flows into the chimney is influenced to a lesser extent by the liquid trickling downward. The diametral widening is preferably made continuous, for example in the form of a radius. It is also possible for the diametral widening to have a conical, elliptic or parabolic configuration.

In order to guide the hood between the first and the second valve position, it is possible, for example, to connect the lower tray and the upper tray of the lock to a sleeve and to guide the hood in the sleeve. In order to ensure that the liquid flows out of the lock, for example, orifices are formed in the sleeve and are arranged directly above the lower tray in the lock, so that the liquid can flow out from the lower tray through the orifices when the valve is opened. Furthermore, it is advantageous to provide in the upper region of the sleeve, below the upper tray, orifices through which gas can flow out of the hood during the movement of the closing element designed as a hood from the first valve position to the second. Furthermore, as a result of the orifices in the sleeve in the region of the lock, it is possible that liquid can flow from the upper tray through the sleeve into the lock when the closing element is in the first valve position and can flow out of the lock when the closing element is in the second valve position.

Alternatively to a sleeve, it is also possible to provide guide pins, between which the hood is guided. For this purpose, preferably at least three guide pins are used, so that the closing element designed as a hood cannot fall out between the guide pins.

When the stop for the closing element designed as a hood is configured in the form of a hood on the upper tray, it is preferable, if a sleeve is accommodated between the lower and the upper tray, that the hood on the upper tray is part of the sleeve between the trays, the sleeve projecting through the upper tray and forming the hood for this purpose.

Alternatively, it is also possible to configure the sleeve such that this projects through the upper tray, and to form at the upper end of the sleeve a stop, against which the closing element designed as a hood abuts in the second valve position. The stop may be designed, for example, as a flanged edge, as a bead, as a rib or else in the form of pins at the upper end of the sleeve.

If the chimney is connected to the closing element designed as a hood, it is preferable, furthermore, if the sleeve has formed on it a stop, against which the closing element designed as a hood abuts in the first valve position. The advantage of this is that the closing element designed as a hood, together with the chimney formed on it, cannot fall out of the valve when the latter is in the first valve position. The stop may in this case be designed, as above, for the chimney fastened to the lower tray. In this case, it must be remembered that the stop should project into the open cross section only to an extent such that the outflow of liquid from the lock is not obstructed. For this purpose, either the stop projects into the interior of the sleeve only to an extent such that the closing element designed as a hood lies on the stop, but the stop does not project into the interior of the hood, or the stop is designed in the form of pins on the sleeve.

If guide pins are used instead of a sleeve, the stop is formed on the guide pins. For this purpose, for example, it is possible to bend the guide pins round at their end, so that the closing element designed as a hood lies on the bent-round ends of the guide pins in the first valve position. Alternatively, it is also possible to provide the guide pins with stop pins, on which the closing element designed as a hood lies in the first valve position.

In order to allow pressure compensation in the column in which the mass transfer process is being carried out, when there is an interruption in the mass transfer process, during which the closing element designed as a hood is in the lower position, it is preferable if a bore is provided in the cover or in the jacket of the hood. If the bore is formed in the jacket, said bore preferably lies above the maximum liquid level in the lock, in order to avoid the situation where liquid can flow out of the lock through the bore.

The cross section of the chimney may be configured in any form. It is likewise possible to configure the cross section, not filled by the chimney, of the orifice in the lower tray in any form. It is especially preferable for the orifice cross section in the lower and the upper tray of the lock to have a circular configuration. It is possible then likewise for the chimney to have a circular configuration with a smaller diameter and to arrange the chimney concentrically in the orifice cross section of the lower tray. Alternatively, it is also possible to configure the chimney in the form of a segment of a circle with a diameter which corresponds to the diameter of the orifice in the lower tray. In this case, the segment of a circle of the chimney may assume any form. For example, it is possible to use the middle cutout of the circle as a cross section for the chimney. Furthermore, the chimney may also comprise a plurality of segments of a circle, and the cross-sectional regions through which the liquid can flow out of the lock are then located between the segments of a circle.

In addition to a circular orifice cross section in the lower tray, it is, of course, also possible to have any other cross section. The orifice in the upper tray of the lock, the closing element designed as a hood and, if provided, the sleeve between the lower and the upper tray are then also designed correspondingly. For manufacturing reasons, a circular cross section is preferred. Moreover, a circular cross section also has the advantage that deposits cannot form in corners.

In order to reduce the entrainment of liquid running out through the chimney by the oppositely directed gas flow, it is preferable, furthermore, if guide elements are provided in the region of the lower orifice, through which the liquid flows out of the lock, and project further into the space below the lock than the chimney. For example, downwardly directed outflow gutters, through which the liquid flows out, may be mounted as guide elements on the chimney. In order to reduce the entrainment of the liquid, the outflow gutters run, for example, obliquely downward in the direction away from the cross-sectional surface through which the gas flows. The liquid consequently flows further away from the orifice through which the gas flows onto the lower tray, the length of the guide elements being selected such that these end in a region in which the gas velocity is so low that no liquid drops are entrained. The outflow gutters used as guide elements may, for example, have a u-shaped, v-shaped or rectangular cross section and are preferably open upwardly.

The valve according to the invention may be used for all gas/liquid processes which are carried out in columns. Such gas/liquid processes are, for example, distillation processes, rectifying processes or absorption processes. During operation, liquid is located on the upper tray above the lock and gas flows from the bottom upwardly through the column and through the liquid on the upper tray. In this case, the closing element designed as a hood is held in the second valve position by the gas flow. In this case, the gas flows upward through the lock and through orifices in the closing element designed as a hood, above the upper tray, through the liquid on the upper tray. After a specific period of time, the gas supply is interrupted. As a result, the closing elements designed as a hood are no longer held in the second valve position and fall down into the first valve position. The orifices in the lower tray of the lock are thereby closed. On account of the absence of a gas flow, the liquid from the upper tray of the lock flows out through the orifices in the upper tray of the lock into the lock. After the gas supply is renewed, the closing element designed as a hood is raised again, so that it is moved into the second valve position again. The cross section, not occupied by the chimney, of the orifice in the lower tray is thereby released, so that the liquid can flow through the open cross section out of the lock onto the upper tray of the lock lying underneath. As a result, in contrast to gas/liquid processes in which only individual trays are used, intermixing of the liquid on the individual trays is prevented, as a consequence of which the effectiveness of the gas/liquid process can be improved.

Embodiments of the invention are illustrated in the figures and are explained in more detail in the following description.

In these figures:

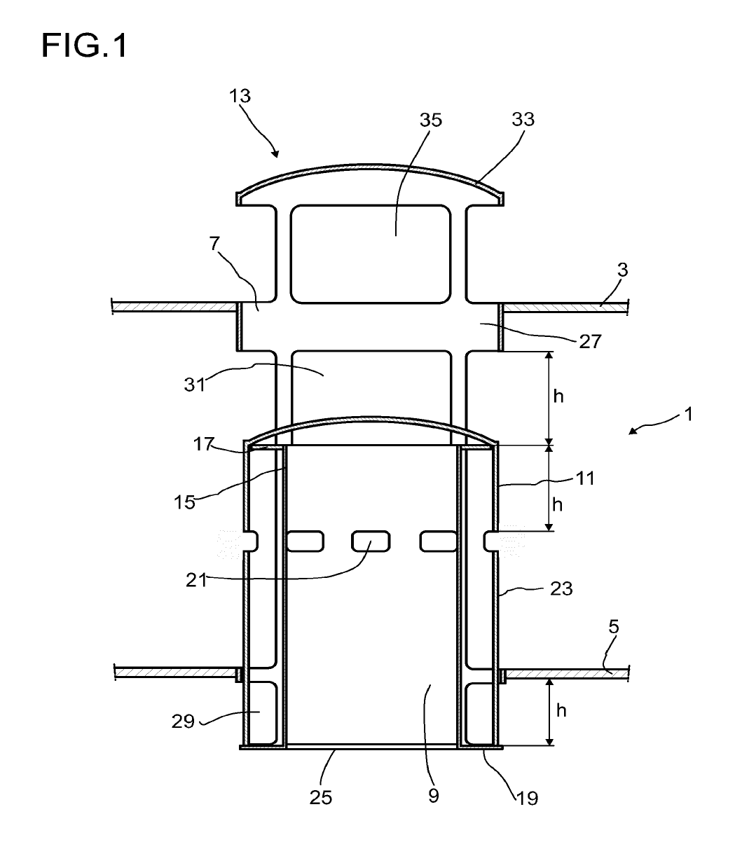

FIG. 1 shows a valve for a lock in a first embodiment,

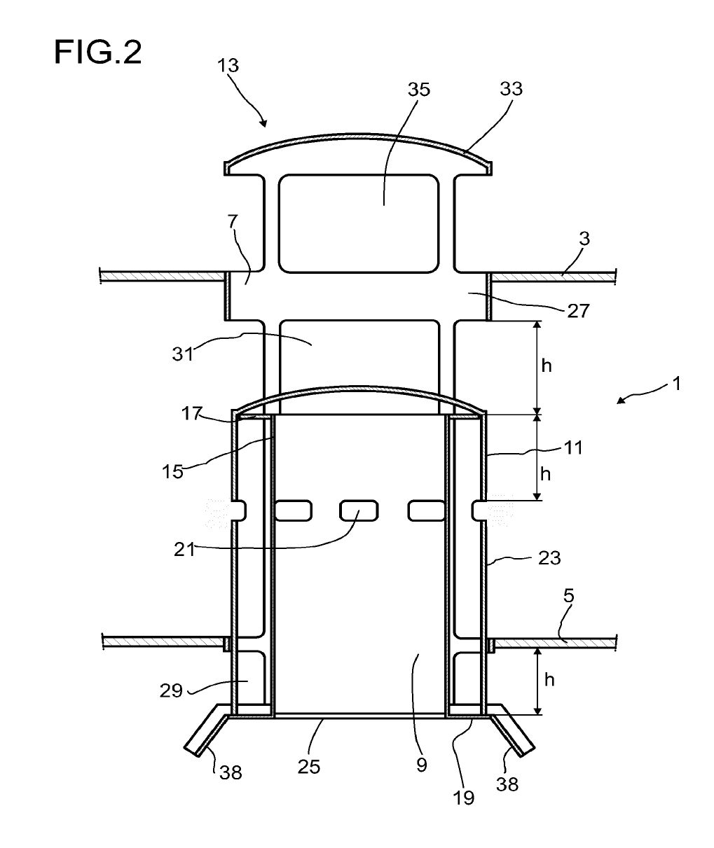

FIG. 2 shows a valve according to FIG. 1 with additional guide elements for the liquid,

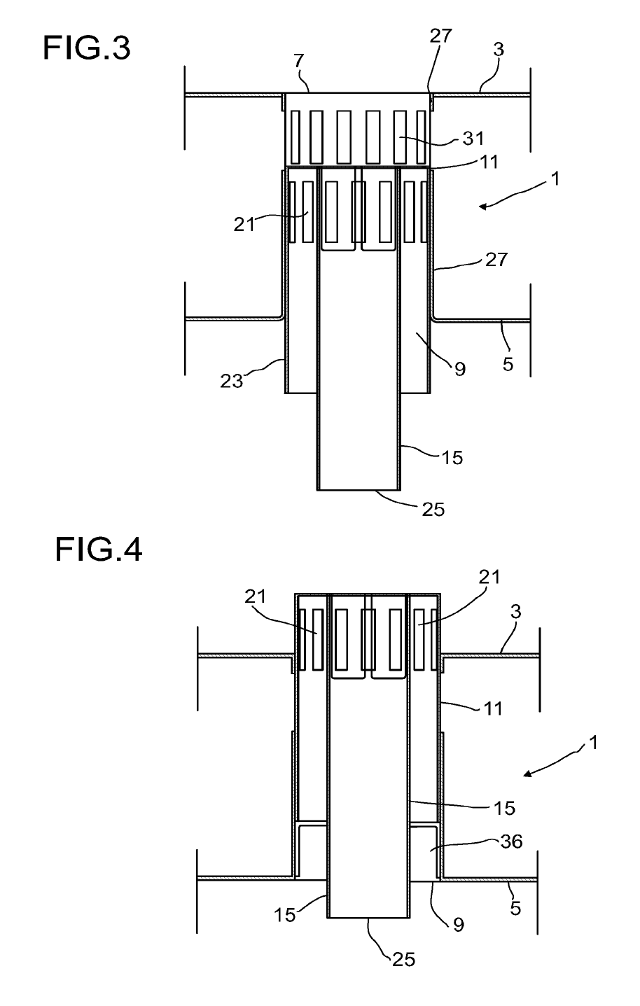

FIG. 3 shows a valve for a lock in a second embodiment, the closing element being in the first valve position,

FIG. 4 shows a valve for a lock in a second embodiment, the closing element being in the second valve position,

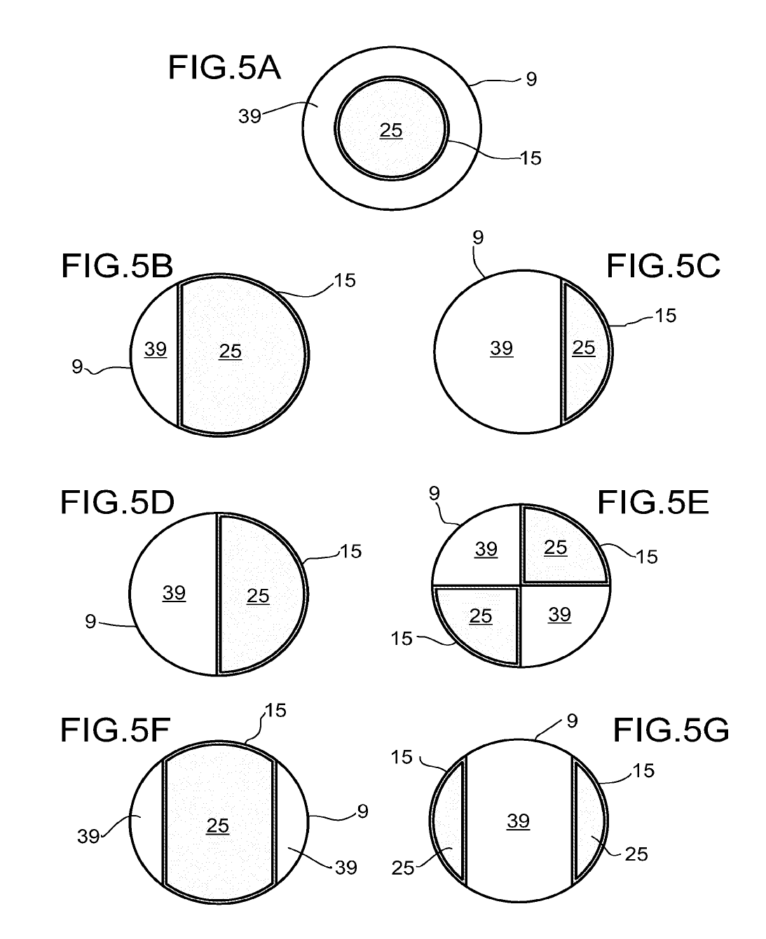

FIGS. 5A to 5G show different cross sections of the chimney,

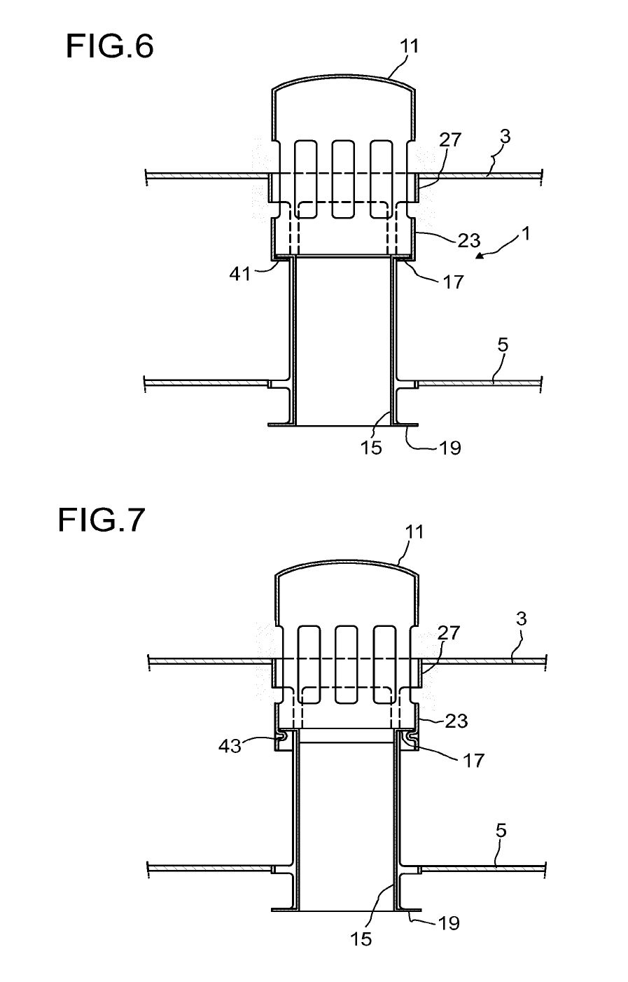

FIG. 6 shows a stop for the closing element designed as a hood in a first embodiment,

FIG. 7 shows a stop for the closing element designed as a hood in a second embodiment,

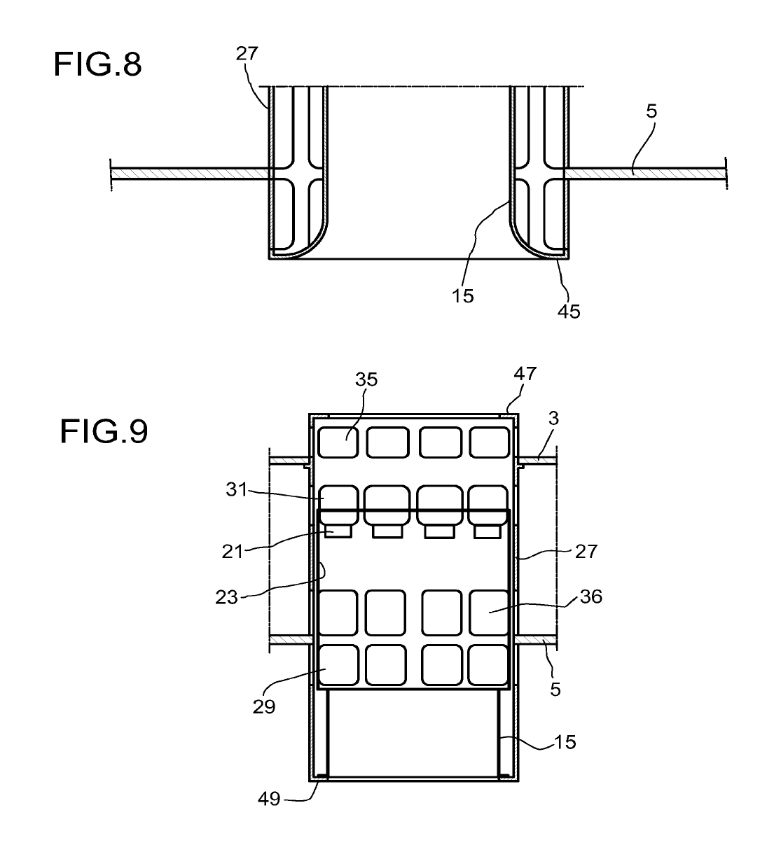

FIG. 8 shows a lower portion of the chimney with a diametral widening,

FIG. 9 shows a valve with a closing element in a third embodiment.

FIG. 1 illustrates a valve for a lock, such as is used in columns for cyclic mass transfer processes.

A lock 1 for a column for cyclic mass transfer processes comprises an upper tray 3 and a lower tray 5. Located both in the upper tray 3 and in the lower tray 5 in each case is at least one orifice 7, 9, through which liquid can flow downward and gas can flow upward. The orifice 7 in the upper tray 3 and the orifice 9 in the lower tray 5 are arranged in alignment one above the other, so that a closing element 11 of a valve 13, which connects the upper tray 3 and the lower tray 5, can be moved through the orifices 7, 9 into the trays 3, 5. According to the invention, the closing element 11 is configured in the form of a hood.

According to the invention, the valve 13 comprises a chimney 15 which is connected firmly to the lower tray 5 and the orifice cross section of which is smaller than the orifice cross section of the orifice 9 in the lower tray. In the embodiment illustrated here, the chimney 15 has at its upper end a ring-shaped widening 17, the diameter of which corresponds to the inside diameter of the closing element 11 designed as a hood. At the start of gas supply, the ring-shaped widening 17 prevents gas from being able to flow into the lock when the closing element 11 designed as a hood is raised. The gas pressure below the closing element 11 designed as a hood is consequently kept sufficiently high to raise the closing element 11 designed as a hood into the second valve position.

So that the closing element 11 designed as a hood can be raised in a fault-free manner and liquid does not flow out of the lock 1 immediately upon the commencement of the lifting movement of the closing element 11 designed as a hood, in the first valve position the chimney 15 and the closing element 11 designed as a hood project by a distance h into the space below the lower tray 5. When gas flow commences, the gas first flows only through a lower orifice 25 into the chimney and consequently exerts a sufficiently high force upon the closing element 11 designed as a hood to raise the latter out of the first valve position. As soon as the closing element 11 designed as a hood has been raised over the distance h, liquid can flow from the lower tray 5 out of the lock. In this case, the liquid flows through the orifice 9 outside the chimney 15. As a result of a ring-shaped widening 19 at the lower end of the chimney 15, the liquid is defected, so that it does not directly counteract the gas flow directed into the chimney. So that the outflowing liquid does not give rise in the lock 1 to a vacuum which at the same time obstructs the further outflow of liquid, the closing element 11 designed as a hood has provided in it orifices 21 through which gas can flow out of the closing element 11 designed as a hood into the lock 1 as soon as the closing element designed as a hood has been raised over the distance h. For this purpose, the orifices 21 are arranged in the jacket 23 of the closing element 11 designed as a hood, such that the top edge of the orifices 21 lies by the amount of the distance h below the upper end of the chimney 15 when the closing element 11 designed as a hood is in the first valve position.

So that the closing element 11 designed as a hood, when it moves out of the first valve position into a second valve position, is moved only in the axial direction and is not tilted, in the embodiment illustrated here the closing element 11 designed as a hood is guided in a sleeve 27. So as not to obstruct the liquid flow and gas flow, the sleeve 27 has formed in it, below the lower tray 5, lower orifices 29 through which the liquid can flow out of the lock 1 into the space lying underneath. At the same time, the sleeve 27 and the ring-shaped widening 19 at the lower end of the chimney 15 also serve for holding the chimney 15 in position. For this purpose, the sleeve 27 projects over the distance h into the space below the lower tray 5. So that gas and liquid can flow into and out of the sleeve 27 in the region of the lock 1, orifices 31 are likewise formed in the sleeve 27 inside the lock 1.

In the embodiment illustrated in FIG. 1, the sleeve 27 projects in the form of a hood 33 into a space above the upper tray 3. An upper stop for the closing element 11 designed as a hood is thereby formed, which limits the movement of the closing element 11 designed as a hood in the second valve position. The sleeve 27 has formed in it, above the upper tray 3, upper orifices 35 through which liquid can flow from the upper tray into the lock as soon as the gas flow is no longer sufficiently strong to obstruct the outflow of liquid from the upper tray 3. So that mass transfer can take place, the stop for the closing element 11 designed as a hood is designed, in the second valve position, such that the orifices 21 in the closing element 11 designed as a hood lie above the upper tray 3 in the second valve position, the lower edge of the orifices 21 preferably terminating flush with the upper tray 3. In the second valve position, gas thereby flows through the orifices 21 in the jacket 23 of the closing element 11 designed as a hood and through the upper orifices 35 in the sleeve 27 into the liquid of the upper tray 3, so that intensive mass transfer takes place between gas and liquid of the upper tray 3.

In a cyclic mass transfer process, the gas supply is interrupted after a stipulated time and the entire liquid of a separation tray is conducted onto a separation tray lying underneath. So that remixing does not occur in this case, the liquid first flows into the lock 1 and, after a renewed start of the gas supply, from there onto the separation tray lying underneath. During the mass transfer process, the closing element 11 of the valve 13 is in the second valve position. When the gas flow is terminated, the closing element 11 falls into the first valve position in which the orifice 9 in the lower tray 5 of the lock 1 is closed. So that no liquid can flow out from the upper tray 3 through the lock 1 into the space below the lock 1 during the lifting movement of the closing element 11 out of the second valve position into the first, the orifices 31 in the sleeve 27 are designed such that the spacing of the top edge of the orifices 31 from the upper end of the chimney 15 corresponds to the distance h. Liquid can consequently flow through the orifices 31 into the lock 1 only when the lower edge of the jacket 23 of the closing element 11 designed as a hood closes the orifice 9 in the lower tray 5. This ensures that, when the gas supply is interrupted, the entire liquid from the upper tray 3 is first collected in the lock 1 and cannot flow out through the orifice 9 in the lower tray 5.

FIG. 2 shows a valve for a lock with additional guide elements for the liquid.

The valve illustrated in FIG. 2 corresponds in its set-up essentially to that illustrated in FIG. 1. In contrast to the valve illustrated in FIG. 1, it additionally comprises guide elements in the form of outflow gutters 38 which are arranged at the lower end of the chimney 15. For this purpose, the outflow gutters 38 adjoin the ring-shaped widening 19. By means of the outflow gutters 38, the liquid is conducted away from the lower orifice 25 through which the gas flows. The advantage of this is that the liquid flows out in a region in which the gas velocity is so low that no liquid drops are entrained. For this purpose, as in the embodiment illustrated here, the outflow gutters 38 are preferably oriented obliquely downward at an angle, the run of the outflow gutters 38 extending away from the lower orifice 25. The cross section of the outflow gutters 38 may, for example, be u-shaped, v-shaped or preferably rectangular, the outflow gutters 38 preferably being open upwardly.

Guide elements of this type, for example outflow gutters 38, may be used whenever the chimney is connected firmly to the lower tray 5 of the lock 1, as is also the case in the embodiments shown in FIGS. 6 and 7. In embodiments, such as those shown below in FIGS. 3, 4 and 9 in which the chimney is connected to the closing element, corresponding guide elements may be dimensioned or mounted merely such that the function of the valve is not obstructed as a result.

A second embodiment of a valve for a lock in a column for cyclic mass transfer processes, in a first valve position, is illustrated in FIG. 3. FIG. 4 shows the closing element according to the embodiment illustrated in FIG. 3 in a second valve position.

In contrast to the embodiment illustrated in FIG. 1, in the embodiment shown in FIGS. 3 and 4 the chimney 15 is connected to the closing element 11 designed as a hood. So that, when the outflow of liquid from the lock 1 commences, the orifice 9 in the lower tray 5 is not filled completely with liquid, so that the gas flow is interrupted or weakened, the chimney 15 is in this case longer than the jacket 23 of the closing element 11 designed as a hood. As a result, the liquid first flows through the cross section, not filled by the chimney 15, of the orifice 9 in the lower tray 5, and the gas can still flow through the orifice 25 into the chimney 15.

When the gas supply is interrupted, the closing element 11 designed as a hood is in the first valve position illustrated in FIG. 3. Since the jacket of the closing element 11 designed as a hood projects downward through the orifice 9 in the lower tray 5, the orifice 9 is closed, so that no liquid can flow out of the lock 1 into space lying below the lock. All the orifices which would enable the liquid to flow out of the lock are closed.

When the gas supply is restarted, the closing element 11 designed as a hood is raised by gas flowing into the chimney 15 and into the interspace between chimney 15 and jacket 23. Since the jacket 23 projects downward through the lower tray 5 into the space underneath the lock 1, the closing element 11 designed as a hood first has to be raised until the lower end of the jacket 23 is above the lower tray 5, so that the liquid can flow out of the lock. For this purpose, as may be gathered from FIG. 4, orifices 36 are formed in the sleeve 27 directly above the lower tray 5. The liquid can flow through these orifices 36 in the sleeve 27 through the orifice cross section, not filled by the chimney 15, of the orifice 9 in the lower tray 5 and out of the lock 1. Since the chimney 15 projects downward out of jacket 23 of the closing element 11 designed as a hood, gas can still flow into the chimney 15 and raise the closing element 11 further, while at the same time the liquid flows out of the lock 1 into the space lying underneath. Since the liquid starts to flow out of the lock 1 only after the closing element 11 is already in movement, this ensures that the entire liquid remains on the upper tray 3 of the next lower lock and no liquid flows out further through the next lower lock while the gas supply is being started. The mass transfer process can thereby be further optimized.

So that the liquid can flow out of the lock 1 during the lifting movement of the closing element 11 and no vacuum is formed in the lock, which would cause liquid to be sucked into the lock and the outflow of liquid thereby interrupted, orifices 21 are formed in the jacket 23 of the closing element 11 designed as a hood and orifices 37 are formed in the chimney 15. Both the orifices 21 in the jacket 23 and the orifices 37 in the chimney are in this case preferably arranged in the upper region of the closing element 11 designed as a hood. As soon as the orifices 21 in the jacket 23 overlap orifices 31 in the upper region of the sleeve 27, gas can flow out of the chimney and out of the region below the jacket 23 through the orifices 21, 31 into the lock in order to compensate the pressure.

As a result of the gas flow, the closing element 11 designed as a hood is raised further until it has reached the second valve position illustrated in FIG. 4. In the second valve position, the orifices 21 are located at least partially above the upper tray 3, so that the gas can flow out through the orifices 21 into the space above the upper tray 3. Since liquid is located on the upper tray during the mass transfer process, the gas is conducted through the liquid.

As soon as the gas supply is interrupted again, the closing element 11 designed as a hood falls again into the first valve position illustrated in FIG. 3, with the result that the orifice 7 in the upper tray is released, so that the liquid can flow out from the upper tray through the orifices 31 in the sleeve 27 into the lock.

So that, during the lifting movement of the closing element 11, the gas flow is not obstructed by liquid flowing out of the lock 1 and at the same time the liquid is not prevented by the gas flow from flowing out of the lock 1, the chimney 15 is configured such that it fills only part of the orifice cross section of the orifice 9 in the lower tray 5. Possible variants for the configuration of the orifice 25 of the chimney 15 are illustrated in FIGS. 5A to 5G. In this case, the orifice 9 in the lower tray 5 is in each case of circular shape. However, in addition to the circular shape, illustrated here, for the orifice 9, the orifice 9 may also assume any other cross section.

In the embodiment illustrated in FIG. 5A, the chimney 15 likewise has a circular cross section. The chimney 15 is in this case arranged concentrically in the orifice 9. However, an eccentric arrangement would likewise be possible. It would also be possible to configure the chimney with a cross-sectional surface in another shape, for example as a polygon with at least three corners, as an ellipse or in any other form. What must simply be remembered is that the cross-sectional surface of the orifice 25 of the chimney 15 is smaller than the cross-sectional surface of the orifice 9 in the lower tray 5, and that the maximum extents are selected such that the chimney 15 does not intersect the orifice 9, but is located completely in the orifice 9.

Different variants in which the chimney is configured in the form of a segment of a circle are illustrated in FIGS. 5B, 5C and 5D. In this case, in FIG. 5B the cross-sectional surface of the orifice 25 in the chimney is larger than the free cross-sectional surface 39 of the orifice 9, in the embodiment illustrated in FIG. 5C the cross-sectional surface of the orifice 25 in the chimney is smaller than the free cross-sectional surface 39 of the orifice 9, and in the embodiment illustrated in FIG. 5D the two cross-sectional surfaces 25, 39 are of equal size.

In the embodiment shown in FIG. 5E, the chimney has a cross section in the form of two circle sectors. Alternatively, it is also possible to configure the chimney with a cross section of only one circle sector or else of a plurality of circle sectors. Nor is it necessary for the circle sectors to have in each case a center angle of 90°. The center angle of the individual circle sectors may assume any other value. It is merely necessary to ensure that the overall cross-sectional surface of the orifice 25 of the chimney 15 is smaller than the overall cross-sectional surface of the orifice 9 in the lower tray 5.

In the embodiments illustrated in FIGS. 5F and 5G, in FIG. 5F the cross section 39, not filled by the chimney 15, of the orifice 9 is configured in the form of two axially symmetrical segments of a circle which lie opposite one another, and in the embodiment illustrated in FIG. 5G the chimney 15 is, mirror-inverted, in the form of the two axially symmetrical segments of a circle which lie opposite one another.

In FIGS. 5A to 5G, the free cross-sectional surface 39 is in each case the cross-sectional surface of the orifice 9 through which the liquid flows out of the lock 1.

So that the closing element 11 designed as a hood remains respectively in the first and the second valve position, it is necessary in each case to provide a stop which limits the lifting movement of the closing element 11 designed as a hood.

If the chimney 15 is connected to the lower tray 5 via the sleeve 27, the lower stop for limiting the lift in the first valve position is implemented by the ring-shaped widening 19 at the lower end of the chimney 15.

As illustrated in FIG. 1, the upper stop can be implemented in the form of a hood 33 above the upper tray 3. Alternatively, it is also possible to use the ring-shaped widening 17 at the upper end of the chimney 15 as a stop for the second valve position. This is illustrated, for example, in FIGS. 6 and 7.

In the embodiment illustrated in FIG. 6, a flanged edge 41 is shaped at the lower end of the jacket 23 of the closing element 11 designed as a hood. In the second valve position, the closing element 11 designed as a hood abuts with the flanged edge 41 against the ring-shaped widening 17 at the upper end of the chimney 15, so that the lifting movement of the closing element is limited upwardly.

Alternatively, a bead 43 may also be shaped in the jacket 23 of the closing element designed as a hood and abuts against the ring-shaped widening 17 of the chimney 15 in order to limit the lifting movement in the second valve position. This is illustrated, for example, in FIG. 7.

Since, in the embodiment illustrated in FIGS. 3 and 4, the chimney 15 cannot be used as a stop, it is possible here, for example, to shape the upper and the lower stop for limiting the lift in the sleeve 27. The stop can in this case likewise be implemented in the form of a flanged edge or a bead or in the form of pins.

An embodiment in which the chimney 15 has at the lower end a diametral widening 45 which runs without an edge is illustrated in FIG. 8. In contrast to the embodiment illustrated in FIGS. 1, 6 and 7 with a ring-shaped widening 19 at the lower end of the chimney 15, in the embodiment illustrated in FIG. 8 the diameter increases continuously. This avoids a sharp edge at which dead spaces may form, in which, in turn, deposits may occur. As a result of the continuous increase in diameter, the liquid can be deflected smoothly. The continuous increase in diameter may in this case be implemented, for example, as a radius, as illustrated here. Alternatively, a parabolic, elliptic or hyperbolic diameter increase would also be conceivable.

A further embodiment of a valve with a chimney 15 integrally formed on the closing element 11 designed as a hood is illustrated in FIG. 9.

In contrast to the embodiment illustrated in FIGS. 3 and 4, in the embodiment illustrated in FIG. 9 the chimney 15 is formed below the jacket 23 of the closing element 11 designed as a hood. The chimney is in this case formed by a diametral narrowing of the jacket 23.

In the embodiment illustrated in FIG. 9, the jacket 23 of the closing element 11 designed as a hood is configured such that, in the first valve position, lower orifices 29 below the lower tray 5 and orifices 36 directly above the lower tray 5, in a sleeve surrounding the closing element 11 designed as a hood, are closed, in order thereby to prevent the outflow of liquid from the lock 1. During the lifting movement of the closing element 11 designed as a hood into the second valve position, the chimney 15 formed the lower end of the jacket 23 moves in the direction of the lower orifices 29 and the orifices 36 directly above the lower tray 5. As soon as the chimney has reached the orifices 36 above the lower tray 5, the liquid can flow out of the lock through the orifices 36 and the lower orifices 29. At the same time, gas can flow out of the closing element 11 designed as a hood through orifices 21 in the jacket and orifices 31 in the upper region of the sleeve 27 within the lock 1 into the lock 1. As soon as the closing element 11 has reached the second valve position, the gas flows through the orifices 21 in the jacket 23 of the closing element 11 designed as a hood and through the upper orifices 25 in the sleeve 27 into the liquid on the upper tray 3. The lifting movement of the closing element 11 designed as a hood in the second valve position is in this case limited by a flanged edge 47 at the upper end of the sleeve 27 projecting into the space above the upper tray 3.

The stop in the first valve position is implemented by a flanged edge 49 which is formed at the lower end of the sleeve 27 projecting into the space below the lower tray 3. In this case, the chimney, optionally with a ring-shaped widening 19, abuts against the flanged edge 49 in order to limit the lifting movement in the first valve position downwardly.

Alternatively to the flanged edge 47, 49 at the upper and at the lower end of the sleeve 27, any other form of a stop may also be provided, for example a bead or pins which project into the sleeve 27. The stop for the second valve position above the upper tray 3 may also be implemented in the form of a hood, as illustrated in FIG. 1.

In all the embodiments illustrated, it is preferable, furthermore, if the hood 11 has formed in it, above the maximum liquid level in the lock 1, a bore, by means of which pressure compensation can take place when the closing element is in the lower position and the gas flow through the column is thereby interrupted.

### LIST OF REFERENCE SYMBOLS

1 lock
3 upper tray
5 lower tray
7 orifice in the upper tray 3
9 orifice in the lower tray 5
11 closing element
13 valve
15 chimney
17 ring-shaped widening at the upper end of the chimney 15
19 ring-shaped widening at the lower end of the chimney 15
21 orifice
23 jacket
25 lower orifice in the chimney 15
27 sleeve
29 lower orifice
31 orifice in the sleeve 27
33 hood
35 upper orifice
36 orifice in the sleeve 27
37 orifice in the chimney 15
38 outflow gutter
39 cross section not filled by the chimney 15
41 flanged edge
43 bead
45 diametral widening
47 flanged edge
49 flanged edge

1. A valve for carrying out a mass transfer process, the valve accommodated in a separation tray comprising an upper tray and a lower tray, and a lock formed between the upper tray and the lower tray, the valve comprising:
a closing element which is configured such that an orifice in the lower tray can be closed by means of the closing element in a first valve position so that liquid can flow from the upper tray into the lock, and, in a second valve position, the orifice in the lower tray is opened and an orifice in the upper tray is opened so that gas can flow through the lock and through liquid on the upper tray, wherein the closing element is in the form of a hood comprising a jacket having orifices positioned in such a way that, in the second valve position, gas can flow through the orifices into the liquid on the upper tray; and
a chimney which is configured such that a cross section of the chimney is smaller than a cross section of the closing element and is connected to the lower tray and projecting into the lock, or is connected to the closing element.

2. The valve of claim 1, wherein a hood is formed on the upper tray such that the closing element abuts the hood on the upper tray in the second valve position.

3. The valve of claim 1, wherein the chimney is connected to the lower tray, and a stop is formed on the chimney such that the closing element abuts with a stop on the jacket.

4. The valve of claim 3, wherein the stop on the chimney is in the form of a bead or a ring-shaped widening at the upper end of the chimney.

5. The valve of claim 3, wherein the stop on the jacket is a peripheral rib at the lower end of the jacket.

6. The valve of claim 3, wherein the stop on the jacket comprises at least one pin.

7. The valve of claim 1, wherein a lower end of the chimney has a diametral widening.

8. The valve of claim 1, wherein the lower tray and the upper tray are connected to a sleeve, and the closing element is guided in the sleeve.

9. The valve of claim 8, wherein the chimney is connected to the closing element, and a stop is formed on the sleeve such that the closing element abuts the stop on the sleeve in the first valve position.

10. The valve of claim 8, wherein orifices are formed in the sleeve in the region of the lock, so that liquid can flow from the upper tray through the sleeve into the lock when the closing element is in the first valve position, and can flow out of the lock when the closing element is in the second valve position.

11. The valve of claim 1, wherein the chimney and the orifice in the lower tray are configured such that gas flows through the chimney from the bottom upward and liquid flows through the cross section of the orifice in the lower tray when the closing element is moved from the first valve position to the second valve position.

12. The valve of claim 1, wherein guide elements for the liquid are arranged at a lower end of the chimney.
